(19) United States
(12) Patent Application Publication
(10) Pub. No.: US 2003/0231821 A1
(43) Pub. Date: Dec. 18, 2003

(54) Integrated optical crossbar switch

(76) Inventors: William L. Clarke, Soquel, CA (US); Jules D. Levine, Santa Clara, CA (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/170,213

(22) Filed: Jun. 13, 2002

(51) Int. Cl. G02B 6/35

(52) U.S. Cl. 385/17; 385/16

(57) ABSTRACT

Integrated optical crossbar switching method and apparatus preferably includes structure and/or function whereby switching and addressing circuitry is disposed on a substrate. An insulating layer is disposed on the substrate and on the switching and addressing circuitry. A polycrystalline ferroelectric layer is disposed on the insulating layer. The polycrystalline ferroelectric layer includes a first plurality of optical signal carriers and a second plurality of optical signal carriers, each disposed to receive an optical signal from at least one of the first plurality of optical signal carriers. A plurality of optical switching elements is disposed to (i) receive control and addressing signals from said switching and addressing circuitry, and (ii) to switch an optical signal from one of said first plurality of optical signal carriers to at least one of said second plurality of optical signal carriers. Preferably, PLZT (lead lanthanum zirconate titanate) materials are used in the core and cladding of the optical switching elements.

### BACKGROUND

1. Field of the Invention

The present invention relates to optical crossbar switching method and apparatus.

2. Related Art

Optical switches in optical communications systems can reconfigure a fiber optic network on the order of a millisecond or less. These all-optical switches (OOO) imply that the input signal is optical, the output signal is optical and the switching action occurs in the optical domain. This is to be contrasted with the more common OEO switches where the input signal is optical, the output signal is optical and the signal is controlled in the electrical domain. An OOO switch is said to be transparent to the optical signals sent through the switch. For example, any kind of modulation scheme can be used (analog or digital), any bitrate, and any type of format can be superimposed and transmitted without interfering with one another and without their information being modified within the network. This is to be contrasted with the OEO switch, which is opaque to the feature set described above.

In some applications involving reconfiguration, the switch directs a certain input fiber to a certain output fiber in order to optimize the optical network performance, or to connect certain subscribers of an internet service and disconnect others. In other applications (involving protection), the switch changes the routing of a signal from a faulty fiber (e.g., caused by fiber breakage) to a backup fiber. In all these cases, it is advantageous if the light is transmitted through the switch with minimal insertion loss, minimal crosstalk, and minimal sensitivity to polarization.

It is important that such a switch be inexpensive, and this is where the lead lanthanum zirconate titanate (PLZT) family of switches hold much promise. These switch materials have high electro-optical coefficient (about 10× higher than that of LiNbO₃), and as a result, can be made 10× more compact. This gives a high port count on a small size chip. For example, it is possible to have a 16×16 optical switch using PLZT technology on 1 mm pitch, making a chip size of only 1.6 cm on a side. In LINbO₃, this would require a chip of 16 cm on a side. The technology for forming the materials is thin film deposition on a readily available substrate such as sapphire.

A PLZT switch is described in U.S. patent application Ser. No. 09/839,237, filed Apr. 23, 2001 and entitled “Electro-optical Waveguide Switching Method and Apparatus” incorporated herein by reference. This patent application discloses many of the advantageous features outlined above. In addition, the electrodes and the waveguides occupy the same channel, so this simplifies the design considerably. However, it was subsequently found that there are two drawbacks with this concept: (i) sensitivity to waveguide polarization; and (ii) errors introduced during transient pulsing of the crossbar switch. These problems are alleviated in the present invention.

### SUMMARY OF THE INVENTION

The present invention is capable of providing an integrated optical crossbar switch array providing low crosstalk, low insertion loss, and capable of switching a large number of optical signals with reduced noise/loss.

It is thus an object of the present invention to provide an optical crossbar switch array adapted for use in telecommunications applications where signal loss needs to be minimized.

According to a first aspect of the present invention, an integrated optical crossbar switch array includes structure and/or function whereby a CMOS controller is disposed on a silicon substrate at a location separate from a matrix of optical crossbar switches. The controller includes control circuitry and addressing circuitry for controlling and addressing the matrix of optical crossbar switches. The controller is integrated on the same substrate as the matrix of optical crossbar switches but disposed separately therefrom.

According to a second aspect of the present invention, optical signal switching apparatus includes switching and addressing circuitry disposed on a substrate. An insulating layer is disposed on the substrate and on the switching and addressing circuitry. A polycrystalline ferroelectric layer is disposed on the insulating layer. The polycrystalline ferroelectric layer includes a first plurality of optical signal carriers and a second plurality of optical signal carriers, each disposed to receive an optical signal from at least one of the first plurality of optical signal carriers. A plurality of optical switching elements is disposed to (i) receive control and addressing signals from said switching and addressing circuitry, and (ii) to switch an optical signal from one of said first plurality of optical signal carriers to at least one of said second plurality of optical signal carriers.

According to a third aspect of the present invention, a method of selectively switching optical signals between a first plurality of optical signal carriers and a second plurality of optical signal carriers, includes the steps of, (i) disposing a plurality of optical switching elements so as to switch an optical signal from one of the first plurality of optical signal carriers to at least one of the second plurality of optical signal carriers; (ii) disposing a plurality of electrodes adjacent the plurality of optical switching elements; and (iv) controlling said plurality of electrodes to switch an optical signal from one of the first plurality of optical signal carriers to at least one of the second plurality of optical signal carriers such that the switched optical signal is polarization independent.

According to a fourth aspect of the present invention, a method of manufacturing an optical signal switching device, includes the steps of: (i) forming electrode circuits on a substrate; (ii) disposing a PLZT cladding layer on the electrode circuits; (iii) disposing a PLZT core layer on the PLZT cladding layer; (iv) forming at least two optical waveguides and at least one optical switching element in the PLZT core layer; (v) disposing another PLZT cladding layer on the at least two optical waveguides; and (vi) disposing another electrode circuit on the another PLZT cladding layer.

### BRIEF DESCRIPTION OF THE DRAWINGS

FIG. 1 is a schematic diagram of a 2×2 Optical Crossbar Switch array.

FIG. 2 is a schematic diagram of a top view of a polarization-independent coupler according to a preferred embodiment of the present invention.

FIG. 3 is a schematic diagram of a cross-section of the polarization-independent coupler of the FIG. 2 embodiment.

FIG. 4 is a schematic diagram of another cross-section of the polarization-independent coupler of the FIG. 2 embodiment.

FIG. 5 is a schematic diagram of a method of fabricating a waveguide coupler according to the present invention.

FIG. 6 is a schematic representation of induced index changes for z′ polarization.

FIG. 7 is a schematic representation of induced index changes for x′ polarization.

FIGS. 8 and 8a are schematic diagrams of a 2×2 Optical Crossbar Switch array according to a preferred embodiment of the present invention.

FIG. 9 is schematic circuit diagram of a 2×2 memory element array according to a preferred embodiment of the present invention.

FIG. 10 is schematic circuit diagram of analog switches for a predetermined switching element according to a preferred embodiment of the present invention.

FIG. 11 is a schematic diagram of a 4×4 Optical Crossbar Switch array according to another embodiment of the present invention.

FIG. 12 is a functional diagram of an Optical Crossbar Switch according to the present invention.

### DETAILED DESCRIPTION OF THE PRESENTLY PREFERRED EMBODIMENTS

1. Introduction

An integrated N×M optical crossbar switch according to the present invention preferably uses a polycrystalline ferroelectric thin film deposited on a silicon substrate. The switch can find many applications in reconfiguring optical communications systems where optical signals on optical fibers entering the switch input are directed to other optical fibers exiting the switch output. The ferroelectric material preferably is a member of the PLZT family, involving lead, lanthanum, zirconium, and oxygen, and thus has a very large electro-optical coefficient on the order of 100-400 pm/volt, both in thin film form and in bulk form. The substrate silicon provides the switching and latching function to address and maintain voltages at the selected crossbar elements. This approach results in a solid state, non-blocking optical switch with low insertion loss, low crosstalk, and polarization independence, addressable by N+M external control lines. Because of the availability of known methods for processing silicon wafers and depositing PLZT, the cost of manufacture of the optical switch is extremely low compared to competing technologies, such as micro-electrical-mechanical (MEMS) switches. The proposed design represents a substantial improvement over known optical switches. For example, certain features such as polarization independence and non-blocking switching are not found in known optical switches.

While the present invention will be described with respect to optical switches used in telecommunications applications, it is to be understood that such switches also may be used in fields such as specialized networking applications, such as are required for distributed high data rate multiprocessing computer systems.

2. A Basic Optical Crossbar Switch

A preferred feature of the present invention is to implement the optical waveguide and electro-optical coupler elements of the optical switch with a polycrystalline thin film, which is deposited on a thin layer of silicon dioxide (SiO₂) on a silicon substrate. Most if not all of the electrical control circuitry and addressing logic is fabricated on the silicon wafer by a standard high voltage CMOS process, and is isolated from the optical layer by the SiO₂ film. Hence, the optical transport and coupling functions of the switch are separate from the electrical control and addressing functions, so that the material used for the optical functions can be separately optimized for low losses, low crosstalk, low zero field birefringence, and high electro-optical coefficient. Furthermore, the control circuitry can contain an adaptive function which will minimize crosstalk and polarization dependence with respect to process and temperature variations.

In one embodiment of the invention, the core and cladding materials used for the optical waveguides and electro-optical couplers are made from various combinations of polycrystalline and amorphous thin films of PLZT (Lanthanum doped Lead Zirconate Titanate ) whose structural, optical, and electro-optical properties have been expounded by Teowee and associates in: G. T. Teowee, “Optical properties of sol-gel derived PZT thin films” SPIE Vol 1758 Sol-Gel Optics II (1992) 236; G. T. Teowee, et al., “Optical properties of sol-gel derived La-Doped PbTiO3 films” SPIE vol 2288, SolGel Optics III (1994) p. 599; G. T. Teowee, et al., “Optical losses in sol-gel derived Lead Lanhanum Titanate Waveguides” Microelectronic Engineering 29 (1995) 323; and G. T. Teowee, et al., “Electro-optic properties of sol-gel derived PZT and PLZT thin films” Microelectronic Engineering 29 (1995) 327, all of which are incorporated herein by reference.

The core material is of the form Pb₍₁₋ₓ₎ Laₓ (Zr_{y}Ti_{(1-y)})_{(1-x/4)} O₃, where x is the fractional concentration of La in the allowable range for PLT of 0<=X<=0.28 corresponding to 18% La, and y is the fractional concentration of Zr in the allowable range for low La content of range 0<=y<=1.0. For low values of Zr content, the material resembles PLT and the material exhibits very low losses due to the small grain size (˜10 nm) of its poly-crystalline structure. In the presence of an electric field, these thin films, in general, exhibit both linear and quadratic electro-optical effects, which can be used to make electrically-controlled optical switch elements. Furthermore, the PLT thin film materials can be processed at relatively low temperatures (e.g. 450° C. to 500° C.). This allows the fabrication of the optical waveguide structures on wafers which are fabricated by a standard CMOS process without damaging the underlying CMOS circuitry.

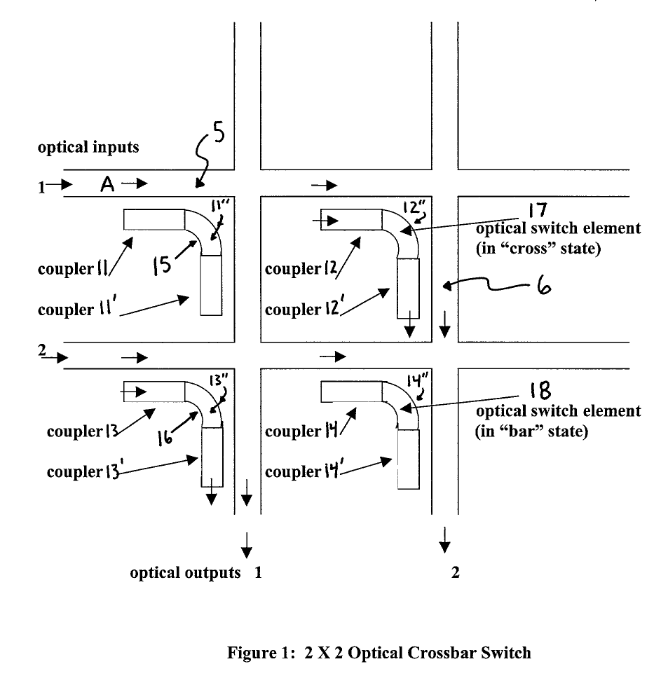

FIG. 1 shows the general configuration of the proposed N×M crossbar permutation switch. Each of the N optical inputs can be routed to any of the M outputs by means of N*M optical switch elements at the crosspoints. The rows and columns of the switch are optical waveguides which are fabricated on the same plane and intersect at the crosspoints, as shown.

Each of the optical switch elements 15, 16, 17, 18 can be either in the “cross” or “bar” states. In FIG. 1, the switch elements 17, 16 at the upper right and lower left are shown in the cross state, and the switches 15, 18 at the upper left and lower right are in the bar state. The meaning of the cross and bar states are will now be discussed.

The switch configuration of FIG. 1 shows a “reverse” permutation, i.e., the optical input 1 is routed to the optical output 2, and the optical input 2 is routed to output 1. For example, as optical power propagates from input 1, along the optical waveguide 5 comprising the first row of the crossbar switch, it first encounters the switching element 15 at the upper left, which is in the bar state. This means that coupler 11 is in a state such that no light is coupled from the first row into coupler 11, rather the light just continues to propagate along row waveguide 5, as shown by the arrow A. Hence this switch element 15 is in the bar state. The light then continues along row waveguide 5 until it encounters the switching element 17 at the upper right, which is in the cross state. This means that coupler 12 is in a state such that all of the optical power on the first row is coupled into the semi-circular waveguide segment 12″, as shown, and then into coupler 12′, which then couples all incoming light into waveguide 6. Hence, the switching element 17, which is comprised by coupler 12, coupler 12′, and the semi-circular waveguide segment 12″ connecting them, is then seen to be in the cross state.

In this embodiment, all of these couplers 11, 11′, 12, 12′, 13, 13′, 14, 14′ are preferably polarization-independent directional couplers, which transfer optical energy by coherent interference of the modes which propagate on adjacent waveguide segments. Each coupler employs the electro-optical effect of the PLT material composing the waveguide segments 11″, 12″, 13″, 14″, and also employs both top and bottom electrodes in order to electrically effect both the cross and bar states in a polarization independent manner. The general design of an optical coupler is known from Robert Hunsperger “Integrated Optics—Theory and Technology” Springer Press (1995) p. 114ff (incorporated herein by reference), and a process of making this optical coupler polarization dependent are also known (Ibid, p 142 (polarization insensitive modulator with 14 electrodes)). But, this design requires 14 electrodes per switch element, which is impractical for large area arrays. It will be shown that by novel means described herein, the number of electrodes needed for providing substantial polarization independence can be reduced to 6. The six electrodes are connected to two 2 independent voltage sources and one ground plane. The polarization independent switching elements and the associated electrical control function will now be described.

3. Polarization Independent Coupler Design

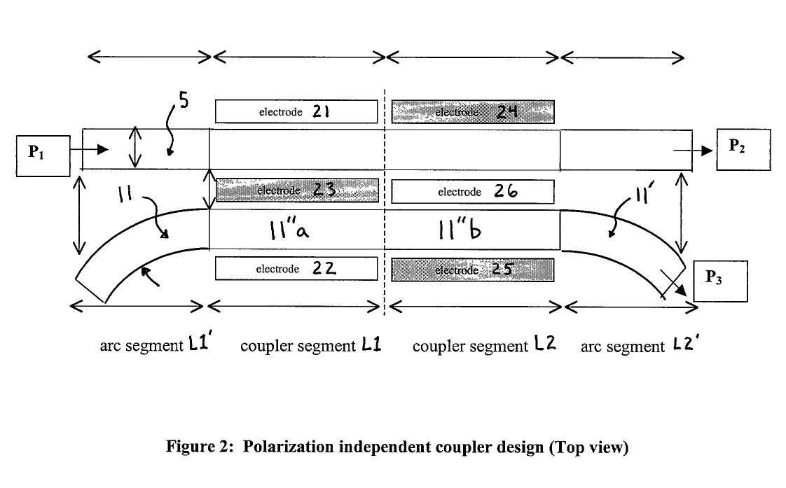

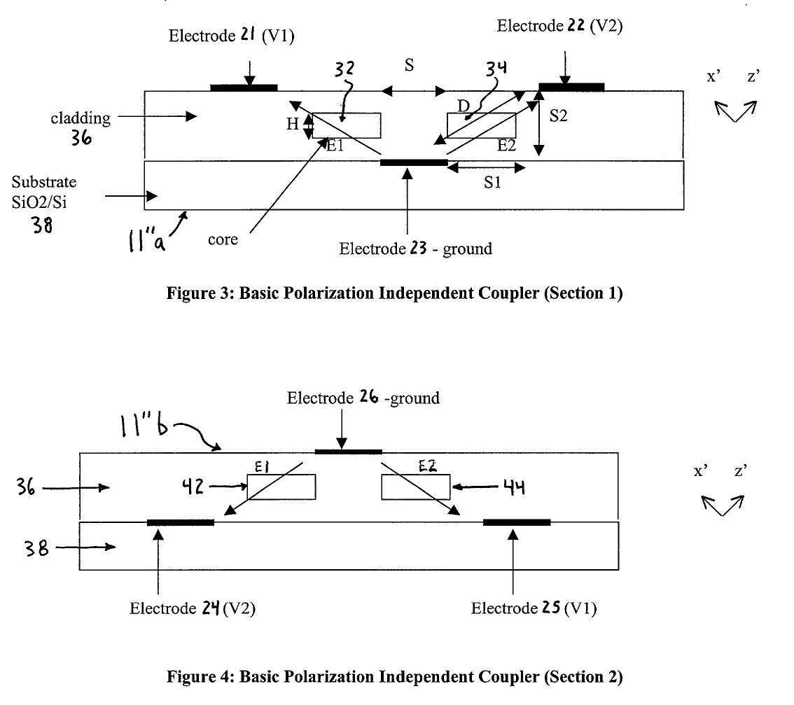

FIG. 2 shows a top view of the preferred polarization-independent coupler design. Optical power P1 is incoming on the upper left waveguide 5, and optical power P2, P3 is outgoing on the upper and lower right waveguides 5, 6. Note that the coupler comprises two coupler segments 11″a, 11″b, respectively of length L1, L2. The arc segments 11, 11′, give a symmetrical structure. FIG. 3 shows the cross section of coupler segment 11″, and FIG. 4 shows the cross section of segment 11″b.

The a schematic elevation view of coupler segment 11″a in this electrode design is shown in FIG. 3, and the schematic elevation view of coupler segment 11″b in this electrode design is shown in FIG. 4.

In this design relating to section 11″ of FIG. 3, there are two rectangular cores 32, 34 of height H which are spaced apart by S and immersed in a cladding region 36 of total height S2. Preferably, H=1 um S=1.5 um; and S2=2 um . The cladding 36 in turn rests on a substrate 38, which comprises silicon having a thin layer ˜1 um SiO₂ insulator on top. An alternate embodiment involves using sapphire as a substrate instead of the Si/SiO₂ described above. Electrodes 21 and 22 are placed above the stack, and electrode 23 (which is a ground connection) is placed below the stack. The electric field E1 points in the general direction of x′, and the electric field E2 points in the general direction of z′. The diagonal directions are defined by the lateral spacing S1 between the edges of top and bottom electrodes and the vertical spacing S2 between them. Preferably, S1=2 um, The diagonal dimension is given by:

D=sqrt(S1²+S2²) (1)

And with the above dimensions of S1 and D2, it is calculated that D=2.82 um.

Each electric field E is obtained from each voltage V with respect to ground by

E=V/D (2)

The electric field E need not be constant across the core region, although this is desirable. The benefit of a spatially-uniform electric field is that the voltage required to, achieve it is less than would be required for a non-uniform electric field. Also, x′ and z′ are diagonal vectors, as shown, and y′ is a vector pointing out of the page. For the preferred case, x′ and z′ are orthogonal which can be obtained by setting S1=S2 in the design in which case D=sqrt(2)*S2.

The chevron-shaped design of FIG. 4 differs from that in FIG. 3 by the various positions of the electrodes. In FIG. 4, the location of the two electrodes 24, 25 is at the bottom of the stack and the ground electrode 26 is at the top of the stack.

4. Principles of Operation

The coupler is preferably a type called “alternating Δβ directional coupler”, as described in H. Kogelnik, R. V. Schmidt: IEEE J. QE-12, 396 (1976), incorporated herein by reference. As in FIGS. 1, 2, and 3, the coupler comprises two coupler segments 11″a, 11″b, respectively of lengths L1, L2 along with arc segments 11, 11′ of lengths L1′, L2′. All segments comprise a pair of channel waveguides composed of cores of index n=n_{co} (where n_{co} is the index of the core), and surrounded by cladding of index n=n_{cl}(where n_{cl} is the index of the cladding). Note that for typical values of W,H, n_{co}, and n_{cl}, the waveguides are single mode, i.e., they only support the TE₀₁ and TM₀₁ polarizations.

The cores of coupler segments 11″a, 11″b are comprised of the electro-optical material poly-crystalline PLZT (poly-PLZT), so that voltages V₁, V₂ applied to the electrodes effect a small change Δn in the index of refraction of the cores. For example, in FIG. 3, electrode 23 is connected to ground (O Volts), electrode 21 is connected to voltage V₁, and electrode 22 is connected to voltage V₂. Hence the field E₁ induces a change Δn(V₁) in the left core 42, and the field E₂ induces a change Δn(V₂) in the right core 44. Note that the fields E₁ and E₂ are perpendicular, and E₁∞x′, and E₂∞z′.

Similarly, FIG. 4 shows the second coupler segment 11″b. In this case, electrode 26 is connected to ground, and electrode 24 and electrode 25 are connected to V₂ and V₁, respectively. In this case, the directions of E₁∞−x′, and E₂∞−z′.

All of the electrodes are preferably made of an optically thin, transparent conducting oxide so that there is sufficient coupling between waveguides, and small optical losses due to absorption. For example, a candidate electrode material would be ITO (Indium Tin Oxide) of SnO₂ (tin oxide), which are known to have very low optical absorption.

5. Fabrication Process

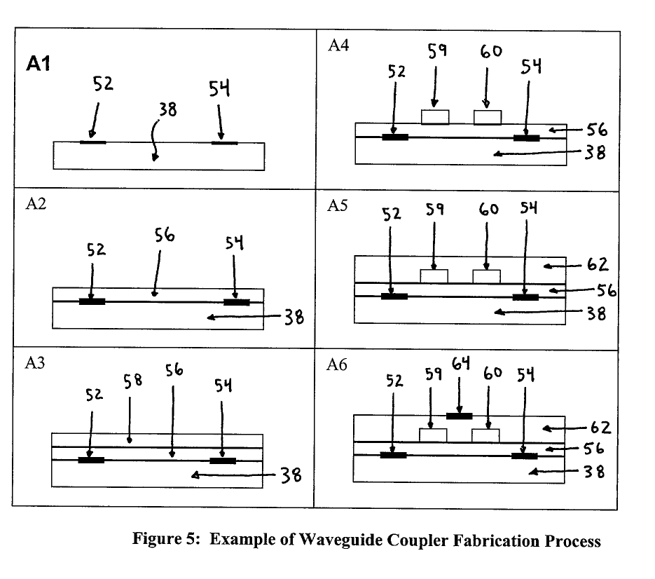

One means of fabricating a coupler geometry using the PLZT family is shown in FIG. 5. The starting material comprises a 700 um wafer of Si coated by a thin 1 um layer of SiO2, as shown in FIG. 5. The first step A1 comprises depositing conductive oxide electrode stripes 52, 54 atop a Si wafer with a silicon dioxide (SiO₂) coating. This is done by applying a thin film of the order of 0.1 to 0.5 um of the electrode material and then etching the material to form the stripes 52, 54. The electrode material is preferably a transparent conductive oxide, like ITO or SnO₂, and it can be deposited by sol-gel or by sputtering. In step A2, a first PLZT family cladding layer 56 is deposited by sol-gel (which is a spin-on process), or by sputtering (which is an evaporation process), to a thickness ˜1 um and with an index n_{cl}. This layer 56 can be crystalline or amorphous. One candidate for this cladding material is PZT 65/45 which, when fired at 500 C, is amorphous with index n_{cl}=2.15.

In step A3, a core layer 58 in the PLZT family is deposited by sol-gel or sputtering. This layer 58 can be crystalline which gives the largest electro-optic coefficient or it can be fine grained polycrystalline with grains<<1 um and with a reasonable electro-optic coefficient. One candidate for this material is PLT 20 fired at 500 C, which is fine-grained polycrystalline material and which has index n_{co}=2.23.

Studies of PLT thin film materials have been done by Teowee et al (see for example: G. T. Teowee, “Optical properties of sol-gel derived PZT thin films” SPIE Vol 1758 Sol-Gel Optics II (1992) 236; G. T. Teowee et al “Optical properties of sol-gel derived La-Doped PbTiO3 films” SPIE vol 2288, SolGel Optics III (1994) p. 599; G. T. Teowee et al “Optical losses in sol-gel derived Lead Lanhanum Titanate Waveguides” Microelectronic Engineering 29 (1995) 323; G. T. Teowee et al, “Electro-optic properties of sol-gel derived PZT and PLZT thin films” Microelectronic Engineering 29 (1995) 327; G. T. Teowee et al “Optical waveguide losses of PZT thin films with various Zr/Ti stoichiometries” Integrated Ferroelecrics” (1997) vol 15 (1997) 281 (all of which are incorporated herein by reference). These studies show that at 500 C, PLT thin film materials are crystalline and they have low optical loss. In general, δ=n_{co}−n_{cl} and in this case δ=0.07.

In step A4, the core layer 58 is then etched back to form the two rectangular waveguides 59, 60, shown side by side in the FIG. 5. The etching of the core layer is preferably done by reactive ion etching (RIE). In step A5, another layer of cladding 62 is deposited either with sol-gel or with sputtering. In the case of sol-gel, excess material, is applied to give a thickness of ˜1 um on top of the core waveguide. In the case of sputtering, the excess material is removed by a final levelizing etch (not shown). Finally in step A6, a top electrode 64 is deposited using conductive oxides as discussed above in step A1.

It has been determined by Teoweee et al that for a molar concentration x<28, PLT (x) is in the ferroelectric tetragonal phase having the appropriate crystal structure which provides for the typical ferroelectric effect (i.e. showing fully developed hysteresis loops). However, for x≧28, PLT (x) is paraelectric (i. e. showing a linear plot with no hysteresis. For such a paraelectric material, there are no ferroelectric domains, hence no scattering of light from domain boundaries. This substantially reduces bulk optical losses in PLT 28. On the other hand, for lower values of x, i.e., x<15, the optical losses are higher. For example, for laser light at 632.8 nm, the optical loss of PLT (28) is quite low, i.e., 1.4 dB/cm, whereas the optical loss of PLT (10) is 3.0 dB/cm. Hence, the preferred molar concentration x of the films used in the principal embodiment will range from x=15 to x=20, in order to make a film with a sufficiently large electro-optical coefficient, and also sufficiently low optical losses.

The preferred process used to make the PLT film uses so-called “sol gel”. Sol gel is a colloidal suspension of particles that is gelled to form a solid solution which can be chemically purified and consolidated at low temperatures. Sol gel can produce ceramics and glasses with better purity and homogeneity than high temperature conventional processes. The precursor solutions are prepared using Pb acetate, Ti alkoxide, and La nitrate. The desired stoichiometries are achieved by adding the appropriate molar percentages of Pb, La, Ti. The sol gel is then applied to the SiO₂/silicon subsystem substrate using a “spin coat” method (e.g., using al Headway Spinner at 2000 rpm for 30 seconds). The film is then in the “green” state, and is of typical thickness 1000 nm.

5. Preferred Parameters

The most preferred design parameters are given below:

1. waveguide core width W (See FIG. 2)

2. waveguide core height H (See FIG. 3)

3. core separation S (See FIG. 2)

4. index difference n_{co}−n_{cl} (core—cladding).

Depending on the applied voltages, the coupler can be in:

1. the “cross” state, where the optical power is transferred to the secondary waveguide (P2≈0, P3≈P1); or

2. the “bar” state, where the optical power retained in the primary waveguide and continues in straight line (P2≈P1, and P3≈0).

It is a property of the stepped Δβ coupler design according to the preferred embodiment that both the cross and bar states are controlled (see, for example, H. Kogelnik, R. V. Schmidt: IEEE J. QE-12, 396 (1976), incorporated herein by reference) by the electrode voltages V₁, V₂, assuming that the coupler segments lengths L1=L2>L₀, where L₀ is a characteristic length depending on the indices n_{co}, n_{cl}, nₛ, and W, S, H. Similarly, the lengths L1′=L2′ need only be long enough so that the separation S′ is sufficient to yield an exponentially small coupling between the cores (e.g., between the straight segment and curved segment in arc segment 1′). Typically, this is satisfied for a value of S′≅3 S. Hence, the lengths L1, L2, L1′,L2′ are not critical parameters.

Note that the index difference between the core and buffer is also not so critical, as a variation in n_{co}−nₛ has only a small effect on the coupling between the waveguide cores. Only the mode shape will be affected.

6. Polarization Independence

For the following discussion, an x′-y′-z′ coordinate system will be used, as shown in FIGS. 3 and 4. This system is rotated by 45° in the x-z plane, and the y′ axis coincides with the light propagation direction y. For example, in FIG. 3, for the first coupler segment, the field E₁ points in the x′ direction, and the field E₂ points in the z′ direction.

The polarization independence of the coupler can be understood by considering light polarized in the x′ and z′ directions. When a fine-grained ferroelectric material has a positive applied voltage V>V_{hysteresis}, which is the hysteresis voltage, the material is called “poled”. This poled condition fixes the polarization for all positive voltages. For a negative applied voltage the poling can be reversed by V<V_{hysteresis}. Therefore a poled fine grain material has a built in electric field (a polarization field) which is colinear with the local electric field. In the case of the above example, these directions lie parallel to the x′ and z′ directions, which are the polarization vectors of the light.

Proof of Polarization independence is as follows:

1. The electro-optical behavior of poly-PLZT exhibits a high degree of field induced birefringence, hence the induced index change Δn will be very different for light polarized in the x′ and z′ directions. For example, by applying a strong diagonal E-field E₁, the PLZT core material can be “poled” in that direction as described above. This happens once. Then, in normal operation, the electrical control field is ALSO applied in this diagonal direction. This is important so that the poly-PLZT material retains temporally stable electro-optical behavior.

2. For the right waveguide core 34 of the first coupler segment 11″a shown in FIG. 3, the index ellipsoid (see, for example, Robert Hunspberger, “Integrated Optics—Theory and Technology” Fourth Edition, Springer Press 1995, pp 131 ff. incorporated herein by reference) of the diagonally poled PLZT material when subject to an applied diagonal field will exhibit negative birefringence (see, for example, C. E. Land et al in “Applied Solid State Science”, edited by R. Wolfe, Academic Press NY 1974 pp 253-277, incorporated herein by reference), i.e., the index ellipsoid will be an oblate spheroid with a diagonal polar axis, so that:

n|_{z′}=nₑ−(½)nₑ³R₃₃E₂ (3)

n|_{x′}=nₒ−(½)nₒ³R₁₃E₂ (4)

where the z′ direction is along the polar axis of the spheroid and where the tensor components R₃₃>0, and R₁₃<0. Here R33 and R13 are the major electro-optical coefficients of the BaTiO₃ type of lattice which is the same as that of the PLZT lattice. Here R33 and R13 correspond to the electro-optical effect on the index of refraction between light with a certain polarization and an electric field in the same direction, and orthogonal direction, respectively. These coefficient R33 and R13 are some of the tensor components as described in Amnon Yariv “Optical Electronics in Modem Communications”, Fifth Edition, Oxford University Press, (1991) p. 326 ff. There are other electro-optical coefficients R51 and R61 for the BaTiO₃ lattice, but it will be shown that their effects are nullified in the proposed design which is polarization insensitive.

3. In the left waveguide core 32 of the first coupler segment 11″a of FIG. 3, the PLZT material is poled in the perpendicular direction, and the applied control field is also applied in that direction. Then in this case, the index ellipsoid is an oblate spheroid with polar axis in the x′-direction, so that:

n|_{z′}=nₒ−(½)nₒ³R₁₃E₁ (5)

n|_{x′}=nₑ−(½)nₑ³R₃₃E₁ (6)

Note that in this case the x′ direction is along the polar axis of the index ellipsoid of the PLZT material, hence depends on the “on-axis” tensor component R₃₃.

4. In the first coupler segment 11″a of FIG. 3, it is clear that, with voltages V₁, V₂ applied to electrode 21 and electrode 22, the index difference An, between the waveguide cores 32, 34 is then obtained for z-polarized light by subtracting equation (3) from equation (5), giving:

Δnₗ|_{z′}=(nₒ−nₑ)−(½)[nₒ³R₁₃E₁−nₑ³R₃₃E₂] (7)

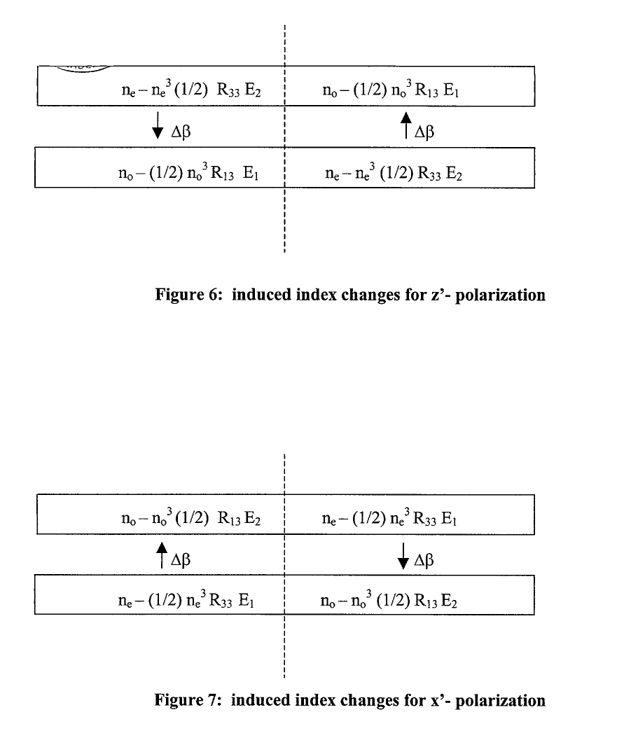

Note that the direction of Δβ₁∝Δn₁ is towards the right waveguide core 34 (i.e., the core poled in the z′ direction), since R₁₃<0, R₃₃>0 (See FIG. 6). Similarly for coupler segment 11″b, find that for the z′-polarization:

Δn₂|_{z′}=(nₒ−nₑ)−(½)[nₒ³R₁₃E₁−nₑ³R₃₃E₂] (8)

The direction of Δβ₂∝Δn₂ is in the direction of the left segment core of the second coupler section 11″b. Hence, the direction of Δβ₁ for the first coupler segment is in the opposite direction as the direction of Δβ₂ for the second coupler segment. Furthermore, it is clear from equations (7) and (8) that |Δβ₁|=|Δβ₂|. Hence, the two requirements for the operation of a stepped Δβ coupler are established for the z′- polarization.

5. It should now be clear from the symmetry of the electrode structure that the requirements of the stepped Δβ coupler are also satisfied for the x′ polarization. Indeed, the index difference between the waveguide cores for coupler segment 1 for the x′- polarization is obtained by subtracting equation (6) from equation (4) giving:

Δn₁|_{x′}=(nₒ−nₑ)−(½)[nₒ³R₁₃E₂−nₑ³R₃₃E₁] (9)

And similarly for coupler segment 2,

Δn₂|_{x′}=(nₒ−nₑ)−(½)[nₒ³R₁₃E₂−nₑ³R₃₃E₁] (10)

So the requirements for the stepped Δβ coupler are satisfied. Furthermore, for the case of E₁=E₂, from (1.8) it follows that the magnitudes:

Δn₁|_{z′}=Δn₂|_{x′}=Δn₁|_{z′}=Δn₂|_{x′} (11)

Hence, this coupler design gives identical results for both polarizations, i.e., the polarization dependent loss (PDL). Also, the polarization dependent crosstalk (PDCT) is identically zero due for the case of square waveguides and is otherwise sufficiently small for the proposed design. Furthermore, the Polarization Mode Dispersion (PMD) is also identically zero. This is true because the optical power is equally distributed between 2 regions with whose electrodes are perpendicular and E₁=E₂. (See FIG. 1). This is true for both the “cross” and “bar” states.

7. Simulation

The coupler of FIG. 1 has been simulated with the following design parameters (square waveguide cross-section with nₛ=n_{cl}):

W=1.4μ

H=1.4μ

S=1.6μ

n_{co}=2.2

n_{cl}=2.1

nₛ=2.1

L1=L2=250μ

L1′=L2′=130μ

radius of curvature of the arcs=r_{c}=400μ

This gives a pitch of 1.0 mm for a unit cell.

Note that modal analysis for these system parameters shows that the waveguides are single mode with effective indices:

n_{eff}(TE mode)=2.131765 (12)

n_{eff}(TM mode)=2.131018 (13)

For the purposes of the following analysis, the polarization directions x′ and z′ will be used. That is, light with an arbitrary polarization will be resolved into x′-polarized light and z′-polarized light. In general, for light propagating in a single mode waveguide, x′-polarized light (x′-pol) will be a certain linear combination of a TE and a TM mode. Similarly, z′-polarized light will be the orthogonal linear combination of the TE and TM mode. This is just a matter of the frame of reference used to define the principal directions of polarization, as shown in FIGS. 3 and 4.

TABLE 1
OPERATTNG VOLTAGES

| STATE | [Δn] | V1 (volts) | V2 (volts) |
|---|---|---|---|
| BAR | 0.0110 | 27.2 | 32.3 |
| CROSS | 0.0005 | 1.23 | 1.47 |

In Table 1, the absolute values of Δn as used in equations (7)-(10) are given for the cross and bar states that were obtained by simulation. Note that for the cross state, the voltages V1 and V2 are similar, differing by only 16%. For this design, four power supplies are provided for 27.2, 32.3, 1.23 and 1.47 volts.

There is a best case situation where V1=V2 for the bar state, and V1=V2 for the cross state. This occurs for a given combination of materials parameters (such as the indices of refraction of core and cladding and the electro-optic coefficients R₁₃ and R₃₃), and structural parameters (such as the core and cladding dimensions and spacings). For this best case situation, only two voltages would be used—one for the bar state and one for the cross state. But in the general case, four voltages are used, as indicated in Table 1.

8. The Cross State

The condition for a cross state is specified from equations (7)-(10), and in Table 1 as

V1=1.23 volts, V2=1.47 volts, and Δn₁|_{x′}=Δn₂|_{x′}=Δn₁|_{z′}=Δn₂|_{z′}=0.0005

The insertion loss is obtained from:

Loss=10×log (P₃/P₁)|_{cross} (15)

Therefore, Loss (x′-pol)=−0.20 dB

and Loss (z′-pol)=−0.22 dB for light polarized in the x′ and z′ directions.

These values are reasonable, since for an N×N crossbar switch, the light only encounters a coupler which is in the cross state one time.

9. The Bar State

The condition for a bar state is specified from equations (7)-(10), and Table 1 as

V1=27.2 volts, V2=32.3 volts, and Δn₁|_{x′}=Δn₂|_{x′}=Δn₁|_{z′}=Δn₂|_{z′}=0.0110.

The crosstalk is computed as:

Crosstalk=10×log (P₃/P₁)|_{bar} (16)

Therefore, Crosstalk (x′-pol)=−27.9 dB

and Crosstalk (z′-pol)=−28.8 dB

The loss is computed as:

Loss=10×log (P₂/P₁)|_{bar} (17)

Therefore, Loss (x′-pol)=−0.013 dB

and Loss (z′-pol)=−0.011 dB

Note that the Polarization Dependent Loss (PDL) is negligible, PDL(Coupler)=0.002 dB.

10. Analysis of N×N Optical Crossbar Switch

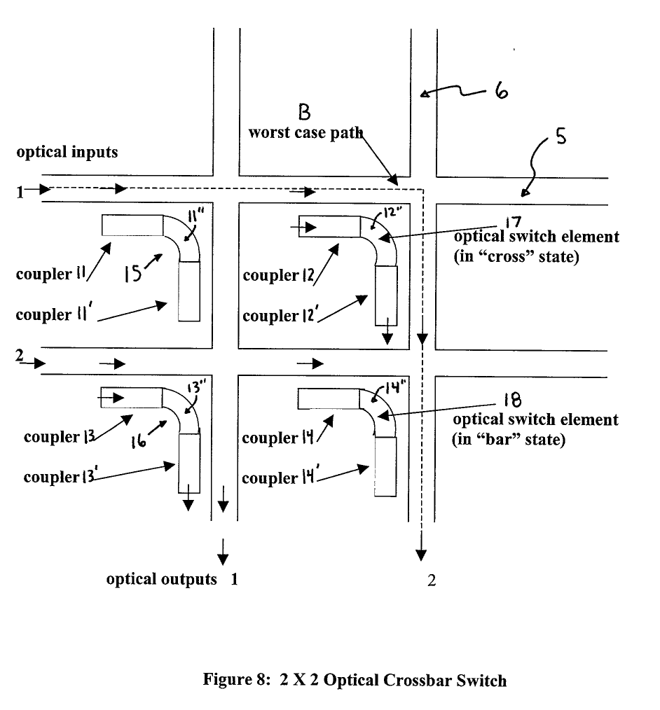

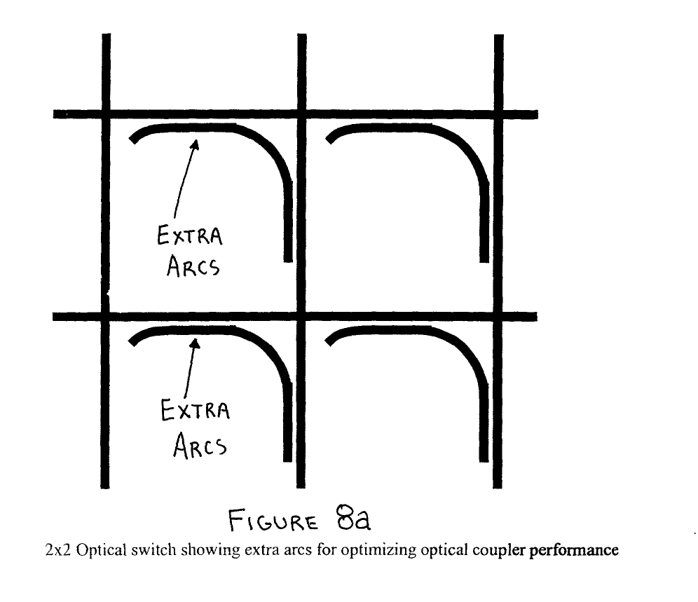

FIG. 8-shows a 2×2 optical crossbar switch, using the same reference numerals as in FIG. 1. Note that there are N² optical switch elements, each of which comprises two couplers and a quarter-arc connecting them. The couplers shown should be considered to be of the stepped Δβ type, as discussed above. In addition there are small additional arc segments on the couplers to the left of the horizontal couplers and on the top of the vertical couplers. These small arc segments, calculated to be nominally 11 degrees of arc, are described first in FIG. 2 and associated text, and their purpose is to optimize the coupler symmetry properties which will give minimal insertion loss, crosstalk and polarization dependence. FIG. 8a shows an embodiment wherein the arcs are extended.

11. Insertion Loss Due to Coupler Leakage

The total insertion loss of a 16×16 switch core only due to the couplers will now be discussed. Note that this does not include losses due to scattering caused by surface roughness, sidewall roughness, or bulk losses to scattering on grain boundaries, etc. These loss mechanisms will be discussed later.

Note that in FIG. 8, the configuration is shown where all switch elements on the diagonal are in the cross state. All others are in the bar state. The worst case insertion loss arises for the longest path B, i.e., when light incoming on the first row 5 is switched to the last column 6. In this case, the light encounters 2×(N−1) elements in the bar state, and only one switching element which is in the cross state. It is further noted that since each of the switching elements are composed of two couplers, light suffers twice the loss of a single coupler.

Then, for the worst case insertion loss due to the couplers:

Total Coupler Loss=2×(N−1)×2×(Coupler Loss)_{bar}+2 (Coupler Loss)_{cross} (18)

So, for a 16×16 switch (N=16), and using the results from above:

Total, Coupler Loss (x′-pol)=2×(15)×2 (−0.013 dB)+2×(−0.20 dB)=−1.18 dB

Total Coupler Loss (z′-pol)=2×(15)×2(−0.011 dB)+2×(−0.22 dB)=−1.10 dB

Note that the Polarization Dependent Loss (PDL) is very low, i.e., PDL=0.08 dB. This is due to the idealized (square) waveguide cross-section and buffer layer.

12. Insertion Loss Due to Waveguide Arcs (Radiation Losses)

Because the index difference δ between the core and cladding is large (δ˜0.1), the fundamental optical modes are well confined. Furthermore, the radius of curvature of the quarter-circular arcs which connect the two couplers is large, i.e., r_{c}=400 μ. Hence the losses due to mode conversion to radiation modes are low. Using the system parameters noted above, simulation produces:

Loss(Quarter-Circular Arc, x′-pol)=−0.004 dB

Loss(Quarter-Circular Arc, z′-pol)=−0.013 dB

Note that the PDL due to the arc is negligible:

PDL(Arc)=0.009 dB

13. Worst Case Total Insertion Loss for 16×16 Switch from Couplers and Arcs

For the worst-case path indicated in FIG. 8, the total insertion loss, including the coupler losses for the cross and bar states, and the loss due to one waveguide arc is then:

Total Loss(16×16, Worst Case, x′-pol)=−1.184 dB

Total Loss(16×16, Worst Case, z′-pol)=−1.113 dB

Total PDL(16×16, Worst Case)=−0.071 dB

14. Total Crosstalk for N×N switch

The worst case for total crosstalk occurs when the switch is fully populated, i.e., when all N inputs and N outputs are in use. In this case, for light incoming on a given row, and outgoing on a given column, there are N−1 couplers (all of which are in the bar state) which can couple spurious signals from the incoming signals on the other N−1 rows.

Furthermore, since each coupler is composed of two couplers, the crosstalk of a switching element is numerically twice the value in dB of that for a single coupler. Then the total crosstalk for an N×N switch is given by:

$$\begin{matrix}Total Crosstalk = 10 \times log {\{ {( N - 1 ) [ {P}_{3} / {P}_{2} ]}^{2} )}_{bar} \} \\ = 10 \times log ( N - 1 ) + 2 \times Crosstalk ( single couple , bar ) ( dB )\end{matrix} \qquad ( 19 )$$

Using the values found in Section 1, for a 16×16 switch:

Total Crosstalk (x′-pol)=10×log (15)+2×(−27.9)=−44.0 dB

Total Crosstalk (z′-pol)=10×log (15)+2×(−28.8)=−45.8 dB

15. Polarization Mode Dispersion (PMD)

For a switch with a 1 mm pitch, the worst case path length will be on the order 3 cm. Then, assuming perfect cancellation of material birefringence when E₁=E₂, then any PMD will only be due to the index difference between the effective indices for the x′ and z′ polarizations as given by:

Δn=n_{eff} (TE mode)−n_{eff} (TE mode)=7×10⁻⁴ hence

PMD=LΔn/c=(3 10⁻²) (7 10⁻⁴)/(3 10⁸)=0.07 ps

16. Analysis of Scattering Losses

In this section, the method of Payne and Lacey (F. P. Payne and J. P. R. Lacey, “A theoretical analysis of scattering loss from planar optical waveguides” Optical and Quantum Electronics 26 (1994), p977, incorporated herein by reference) will be used to show that for a single mode waveguide, there will be an upper bound on the scattering loss:

$$α \leq κ \frac{{σ}^{2}}{{k}_{0} {d}^{4} {n}_{co}} = κ \frac{1}{d} \frac{1}{{k}_{0} d} {\frac{1}{{n}_{eff}} [ \frac{σ}{d} ]}^{2} \qquad ( 20 )$$

where

d=width of waveguide

k₀=2π/λ₀=free space wavenumber

n_{eff}=effective index of core

σ=rms sidewall roughness

κ=0.48 for exponential autocorrelation function (ACF)

and where the loss in dB/cm is given by:

Scattering Loss (dB/cm)=4.3α[1/cm] (21)

Inserting the values of the above system parameters:

$$Scattering Loss \text{(dB/cm)} = 1.216 {{10}^{3} [ \frac{σ ( nm )}{1400} ]}^{2} \qquad ( 22 )$$

For example with an rms sidewall roughness a σ=14 nm:

Scattering Loss (dB/cm)=0.12 dB/cm

This is a relatively small value and is comparable to the values calculated for SOI (Silicon on Insulator) waveguides (see, for example, D. R. Uhlmann and G. T. Teowee, “Ferroelectric Thin films by sol-gel processing” SPIE Vol 3136 (1997) 384, incorporated herein by reference).

17. Analysis of Bulk Losses of Poly-PLZT

The bulk losses of the poly-PLZT material are believed to be due to scattering from grain boundaries. Presently, the size of these grains are unknown, but it is believed that they will be a strong function of processing temperatures; that is, low processing temperatures will result in small grain sizes. Low optical losses will result from grain sizes which are much smaller than the system wavelength (λ=1.55μ).

The data in the literature by Teowee concerns the losses of PLT 15 films at λ=0.6328μ. Teowee, et al. report values of approx. 2.5 dB/cm. The wavelength dependence is presently unknown. However, a crude model which assumes the Rayleigh criterion would predict a reduction in scattering from grain boundaries proportional to the ratio [(0.6328)/(1.55)]²=0.17. This would give the estimate:

Bulk Loss (PLT 15, λ=1.55μ)=0.42 dB/cm

18. Switch Memory Array and Addressing Circuitry

In the previous sections, it has been shown how an N×M optical crossbar switch can be built using a simple polarization independent coupler design. Each optical switching element is built out of two individual couplers, and is constructed so that it is in the cross state when the applied voltage is low at V1=1.23 and V2=1.46 volts. We have also shown that there exists a cross state when the voltage is high at V1=27.2 Volts, and V2=32.3 Volts. In this section, the silicon-based CMOS (Complimentary Metal Oxide Semiconductor) control and addressing circuitry will be described. This circuitry can supply the horizontal and vertical voltages to each switching element in order to allow any one of them to be put in either a cross or bar state.

In an N×M crossbar switch, there are N×M crosspoint switching elements, each of which can be either in the cross or bar state. In the preferred embodiment, the state of any of the N×M switching elements can be separately put in either the cross or bar state by using only a total of N+M external control lines. This is accomplished by the use of an N×M array of single bit memory elements, where each of the N×M memory elements controls the cross/bar state of a corresponding optical switching element. The binary logic state of the memory element controls two SPDT (Single Throw Double Throw) analog switches per coupler, which controls the applied voltages V₁ and V₂ applied to the two different diagonal electrodes of a given coupler. Since there are two couplers per crosspoint switching element, a given binary memory element then controls a total of four SPDT analog switches.

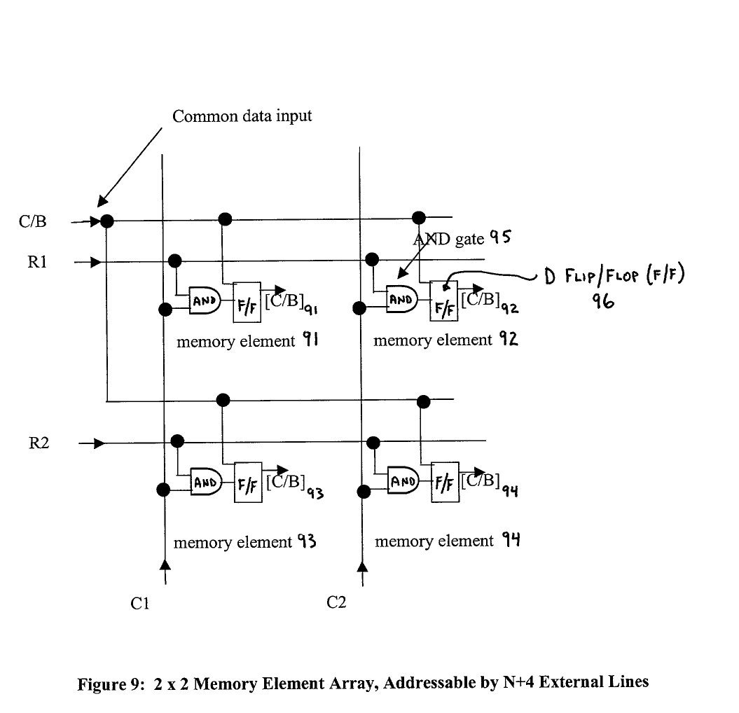

FIG. 9 shows a 2×2 memory element array. In this case, there are N×M=4 memory elements 91, 92, 93, 94, each comprising and AND gate 95 and a D Flip/Flop 96. Each memory element preferably stores a single bit, the output of each memory element can be a “1” or a “0”, as represented by a standard logic state of 5 Volts or 0 Volts. The name of this output signal is “C/B” which stands for “cross” or “bar”. By convention, a logic “1” (5V) will represent the “cross” state, and a logic “0” (0V) will represent the “bar” state. For each memory element ij, the output signal [C/B]ᵢⱼ then will control the “cross” or “bar” state of optical switching element Sᵢⱼ.

In FIG. 9, the state of the N×M memory elements can be separately controlled by the N=2 inputs R1, R2, and M=2 inputs C1, C2. Although this is shown for N=M=2, this method is valid for any nonzero values of N and M, which will now be discussed.

In order to set the state of memory element ij, the common data input C/B is set to a “1” or “0”, depending on whether it is desired to set the state of optical switching element ij to the “cross” or “bar” state. Then, a positive going pulse is provided on the row control input Rᵢ, and also (preferably simultaneously) a positive going pulse is provided on the column input Rⱼ. All of the other row and column inputs are held to a logic “0”, i.e., at ground. For example, to set the memory element 92 to the “cross” state, positive going pulses are simultaneously generated on row input R₁ and column input C₂. The inputs R₂ and C₁ are held at ground. Then, the output of the AND gate 12 is a positive going pulse, which clocks the data signal C/B=1 into the data input of the D Flip/Flop 96 (i.e., memory element 92). Note that all of the outputs from the other AND gates remain in a “0” state, since for all the other AND gates, at least one of the inputs is a logic “0”. Hence, the clock input to these Flip/Flops is not affected, and so their state is not changed. Only the AND gate 95 will have two co-incident positive pulses at its inputs, which will result in a positive pulse on its output which will set the state of memory element 92.

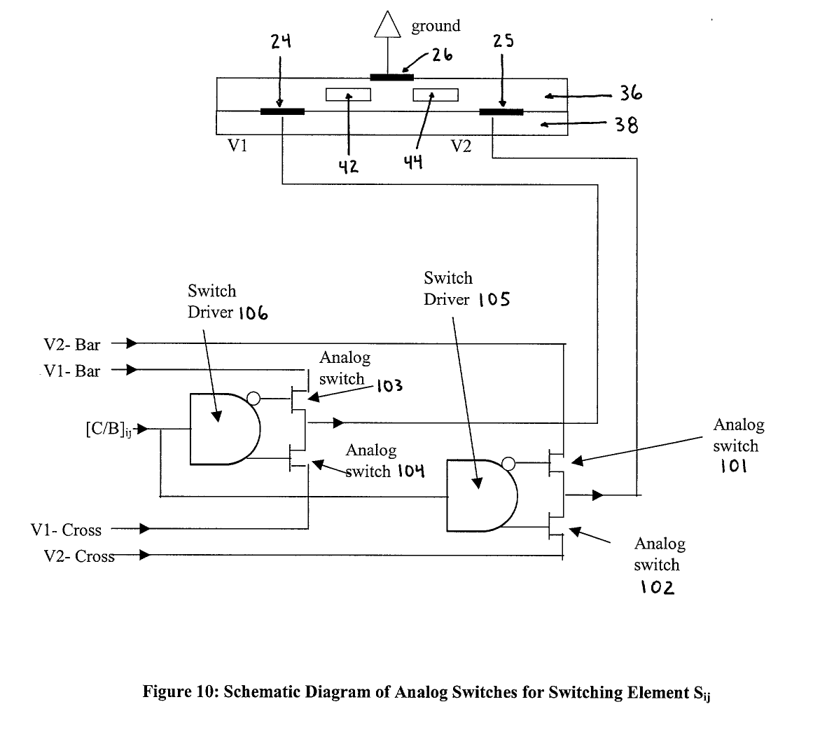

In this way, the logic state of the N×M memory elements can be separately set to the N×M values of [C/B]ᵢⱼ for i=1,2, . . . N and j=1,2, . . . M. Each of the outputs [C/B]ᵢⱼ are connected to an analog switch network (see FIG. 10) corresponding to switching element Sᵢⱼ, which applies the appropriate voltages V_{H} and V_{V} depending on the signal [C/B]ᵢⱼ.

FIG. 10 shows the analog switches and control logic used to control both couplers for a given crosspoint switching element ij. For clarity, only one coupler is shown. The other coupler is connected in parallel and the same voltage are preferably used in it, i.e., both horizontal electrodes are connected together.

First consider the bar state. Voltages V1-Bar and V1-Cross are supplied by external precision voltage sources (not shown). The analog switch driver 106 and the associated analog switches 103 and 104 control which potential (V1-Bar or V1-Cross) is directed to the electrode V1 at the, top of the diagram. V1-Bar and/or V1-Cross is switched to control whether the horizontal and vertical electrodes are connected to the V_{H}, V_{V} power supplies, or to ground. This is controlled by the binary logic signal [C/B]ᵢⱼ, which is connected to the memory element corresponding to this particular crosspoint switch element.

Consider the switching circuitry for one unit cell, as shown in FIG. 10. The signal [C/B]ᵢⱼ is connected to switch driver 106 and to switch driver 105. The outputs of the switch drivers are complimentary, i.e., the lower output is the same logic value as the input [C/B]ᵢⱼ, and the upper output is the logical negation of the input [C/B]ᵢⱼ (as indicated by the circle on the upper output of the switch driver). For example, if it is desired to put the switch element ij into the “cross” state, then [C/B]ᵢⱼ=1, and the lower output of switch driver 106 is a logical “1”, which turns “on” the analog switch 104. The upper output of switch driver 106 is a logical “0”, which turns the analog switch 103 “off” and the analog switch 104 “on”. In this way, it is seen that the line connecting the left electrode is held at V1-Cross. Otherwise, it is held at V1-Bar.

Similarly, if the upper output of switch driver 105 is a logical “0”, this turns the analog switch 101 “off” and the analog switch 102 “on”. In this way, it is seen that the line connecting the right electrode is held at V2-Cross. Otherwise, it is held at V2-Bar. In this way, the state of the N×M memory elements in the memory element array can be separately set using only one common data input, and M+N control lines. Furthermore, the state [C/B]ᵢⱼ of each memory element controls the “cross” or “bar” state of the optical switching element Sᵢⱼ, which comprises two individual couplers and a semi-circular waveguide segment, as shown in FIG. 1. Note that the memory and control function is preferably implemented with silicon-based CMOS circuitry, which is a well known and highly developed process. This results in a robust and reliable method for controlling the optical crossbar switch.

Switching circuitry for other unit cells can be easily obtained by analogy, since the voltage sources are preferably common to all cells.

19. Adaptive System for Control of Electrode Voltages

An adaptive system is a means where the output is sampled and corrected for certain errors. There are two types of adaptive systems: static or dynamic. In a static system, parameter variations from die to die can be “tweaked” at the time of manufacture for minimum crosstalk, and then left unchanged. In a dynamic system, parameter variations over time (such as due to temperature effects) can be continuously adjusted during the life of the device, to adjust the switch array for minimum crosstalk. The following is a description of the configuration of a preferred adaptive system.

Above, a method was given which provides the correct values for voltages V1-bar and V2-bar. This method used as inputs, the expected values of the dimensions, Lo, W, H, etc, electro-optical coefficients R₁₃ and R₃₃, and refractive index difference Δn. In general, these values are not perfectly predictable, due to variations in manufacture and material temperature dependence. Hence, the voltages values V1-bar and V2-bar are approximate values. In this section, an adaptive method to compute the optimal values of these voltages, even when the exact waveguide parameters are not precisely known and are temperature dependent, will be described.

The values V1-bar and V2-Bar found above are a linear approximation to the optimal values, and they are used as nominal values for the optimization procedure, which is implemented by an off-chip sub-system. The optimization algorithm will now be discussed.

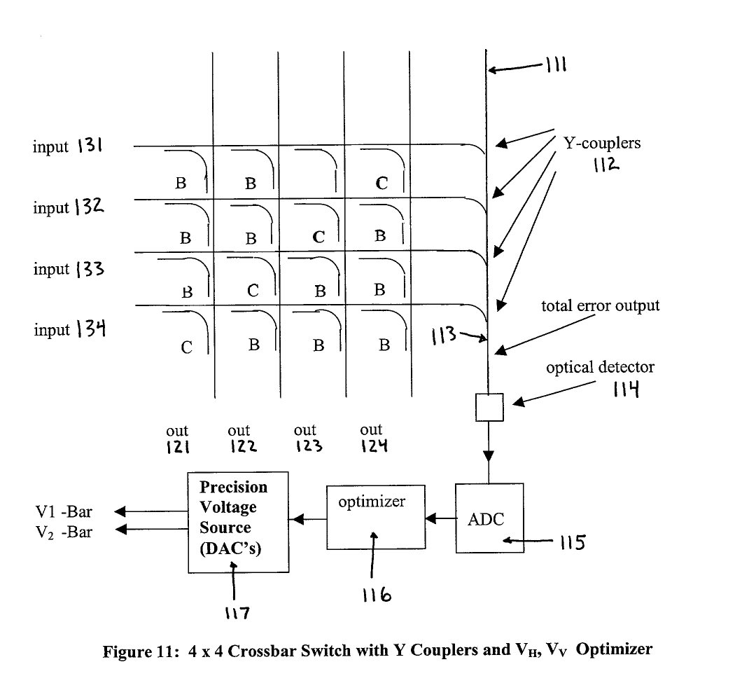

FIG. 11 shows a 4×4 optical crossbar switch, which has been augmented by an additional column waveguide 111, which is coupled to the N rows by N additional “Y” couplers 112. This structure collects all the residual light on the outgoing rows (i.e., the “row error outputs”), and feeds it into a single optical waveguide 113, which thus carries the total error output. This optical signal is then fed to a (preferably) off-chip optical detector 114 and converted to an electrical signal, which is digitized by an analog to digital converter (ADC) 115, which acts as an error input to the optimizer 116. The outputs of the optimizer control a precision voltage source, which can be implemented as high-quality digital to analog converters (DAC's) 117. The outputs of the DAC's are the values V1-Bar and V2-Bar, which set the “bar” state for the row and column couplers for all the optical switching elements Sᵢⱼ

Without loss of generality, it will be assumed that the optical switching elements on the diagonal are in the “cross” state (as denoted by “C” in FIG. 11), and all others are in the “bar” (“B”) state. For the switching elements in the cross state, their horizontal and vertical electrode voltages are set to values as given in Table 1. Note that there is only one cross state in the pathway of a crossbar switch whereas there may be many bar states. That is why the optimization routine occurs for the bar states. For the bar state, the values of V1-Bar and V2-Bar will be optimized so as to minimize the spurious crosstalk power coupled into optical outputs: out 121, out 1222, out 123, out 124, by the switching elements in the bar state. For example, for an optical signal incoming on input 131, and outgoing on out 124, there is spurious crosstalk coupled into out 124 from optical inputs 132, 133, 134 by switching elements S₂₄, S₃₄, S₄₄, which are all in the bar state. This spurious crosstalk coupled into the out 124 is minimized when the error outputs on inputs 132, 133, 134 are maximized. Similarly, the spurious crosstalk coupled into outputs 121, 122, 123 is also minimized when their row error outputs are maximized. Hence, it is the function of the Y couplers 112 to collect all the light from the error outputs on all the rows, and send it to the optical detector 114, where it is converted into an electric signal. This total error signal is then digitized and sent to the optimizer 116, which then causes the precision voltage source 117 to vary V₁₁, V_{V} in such a way as to maximize the total error signal, which will minimize total crosstalk on outputs out 121, out 122, . . . out M, due to spurious coupling from inputs 131,132, . . . input N.

The optimization procedure is as follows:

1. Set V1-Bar=V1-Bar0, and V2-Bar=V2-Bar0, where V1-Bar0 and V2-Bar0 are the nominal values from above.

2. Measure the total error output from the star coupler with the ADC.

3. Set V1-Bar=V1-Bar0+Δ1,V1-Bar=V2-Bar0+Δ2, where Δ1, Δ2 are random increments.

4. Measure the total error output from the star coupler with the ADC

5. IF the value measured in Step 4 is less than that measured in Step 2,

Set V1-Bar=V1-Bar+Δ10, V2-Bar=V2-Bar+Δ20

ELSE

Set V1-Bar=V1-Bar, V2-Bar=V2-Bar

6. Loop back to Step 2

The optimization algorithm executes an endless loop, continuously adjusting the horizontal and vertical electrode voltages V-Bar and V2-Bar in order to minimize the amount of spurious crosstalk coupled into the outputs 121, 122, . . . M, no matter what the variation of material parameters due to process or temperature variations. Furthermore, because the optimization procedure adjusts the horizontal and vertical electrode voltages in tandem, this procedure is polarization-independent, i.e., the crosstalk on the outputs is minimized separately for both the TE and TM polarizations. Hence, this optimization procedure also adaptively maintains the polarization independence of the couplers and hence the polarization independence of the optical crossbar switch.

20. Fabrication of the PLT Optical Crossbar Switch Subsystem

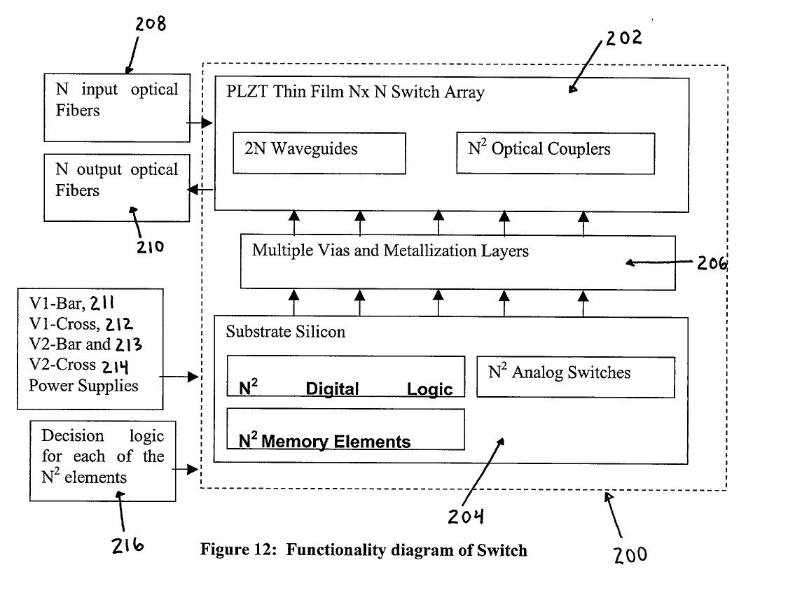

A block diagram of the switch functionality is shown in FIG. 12. The optical crossbar switch 200 is shown as a rectangle enclosed by the dashed lines. The optical crossbar switch 200 comprises two main parts. The upper part is a PLZT thin film N×N switch array 202 and the lower part is the substrate silicon 204. Waveguides and optical couplers are located in the thin film N×N switch array 202, and the logic, memory and analog switching functions are embedded in the substrate silicon 204. A multiplicity of vias 206 is used to connect the metallization layers that support these functions. External to the optical crossbar switch 200 are the following: (i) N input output fibers 208 and N output fibers 210 connecting to the optical communication system of interest, (ii) four power supplies 211, 212, 213, 214, which supply the precision voltages used to switch from the cross state to the bar state, and vice versa, and (iii) logic and controls 216 for changing the state of any of the N² elements in the crossbar switch array.

21. Integration of Optical Switch with Si Based CMOS Controller

The CMOS control and addressing circuitry has been discussed above. The control and addressing circuitry contains a switch memory array, and the associated addressing circuitry required to set and clear any of the N×M memory array elements with N+M control lines. The binary state of each of the memory elements is used to set its corresponding optical switching element to the “cross” or “bar” state by using an analog switch which controls the voltages V_{H}, V_{V} on the horizontal and vertical electrodes. That is, when V₁=1.23, V2=1.46 Volts, the optical switching element in put in the “cross” state, and when V1-Bar=27.2 Volts, and V2-Bar=32.3 Volts, the switch is put in the “bar” state. Thus, the voltages V1-Bar and V2-Bar can be controlled adaptively to minimize spurious crosstalk, so their values will vary slightly, but should approach the nominal values given above. Hence, a CMOS analog switch process technology with an operating voltage of 40 Volts is capable of meeting the desired switching goals.

High voltage CMOS technology is available in an “off the shelf” process. For example, Zarlink Semiconductor, 400 March Road, Ottawa, Canada K2K 3H4, offers a 5V/40V CMOS process capable of implementing both the switch memory array (i.e., the “D” flip-flops and addressing circuitry in 5V technology), and also the analog switches in 40V technology on the same chip. This is done using silicon processing techniques, including wet etching, annealing, and CMP (Chemical Mechanical Polishing).

After the fabrication of the CMOS control subsystem layers is complete, as shown in FIG. 2A, a layer of SiO₂ is deposited, vias are plated up, and metallization lines are interconnected to give the full functionality of the switch array. With a maximum annealing temperature of 500 C. for the amorphous PLZT and crystalline PLT materials in the cladding and core, respectively, it is possible to design a process flow that will enable the fabrication of the optical array without harming the underlying functionality in the Si. It is best to add the interconnect metallization at the last step, since metallization (especially Al metallization) cannot be heated for long at elevated temperatures. Hence, the low annealing temperature of the PLT 15 material is a significant advantage in the integration of the PLT optical layers with the CMOS subsystem.

22. Error-Free Switching

It is advantageous that in a crossbar switch, electrical signals should not introduce errors on unrelated optical output lines. For example, suppose that the m^{th} input row and the n^{th} output column of an M×N array are both vacant, with no optical signals passing and no cross state at the intersection point. Also, suppose that optical signals exist everywhere else in the M-1 rows and N-1 columns of the array. When a transient electrical signal is given to activate the previously vacant m^{th} row and another transient electrical signal is given to activate the previously vacant n^{th} column, these electrical signals should not introduce errors in the optical communication lines exiting at any point of the array.

External memory elements embedded in the substrate Si, as described with respect to FIGS. 9-11, perform a critical buffering function which totally isolates the transient electrical pulses which define each of the N×N elements of the array. This is a notable non-blocking feature in accordance with the crossbar switch array of the preferred embodiment.

In the absence of external memory elements, it is possible to design a switch array using intrinsic PLZT memory elements, but its buffering ability is reduced due to the transient pulse voltage and its finite rise times and fall times. The reason is as follows. The transient pulse voltage on one row or column is insufficient to cause change of state from bar to cross or vice versa, but it can cause a transient unbalance of the optical couplers along the affected row or column. This optical coupler unbalance will create appreciable insertion loss and reflections in that column, which will introduce bit errors and decrease signal-to-noise ratio. In conclusion, intrinsic PLZT memory elements introduce errors while external Si memory elements described above do not.

23. Conclusion

Thus, what has been described is an optical crossbar switch array and method, and apparatus capable of high signal speeds and dense integration, but with ultra low crosstalk, and to methods of making and assembling such a switch array.

The individual components shown in outline or designated by blocks in the attached Drawings are all well-known in the optical switching arts, and their specific construction and operation are not critical to the operation or best mode for carrying out the invention.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An integrated optical crossbar switch array, comprising:
a matrix of optical crossbar switches; and
a CMOS controller disposed on a silicon substrate, said controller including control circuitry and addressing circuitry for controlling and addressing said matrix of optical crossbar switches, said controller being integrated on the same substrate as said matrix of optical crossbar switches but disposed separately therefrom.

2. An array according to claim 1, wherein each optical crossbar switch comprises:
a row optical waveguide disposed to optically intersect a column optical waveguide; and
an optical switching element coupled to said control circuitry and addressing circuitry, and disposed to switch optical energy from at least said row optical waveguide to said column optical waveguide.

3. An array according to claim 1, wherein each optical switching element comprises two optical directional couplers and a 90 degree section of arc.

4. An array according to claim 3, wherein said optical directional coupler comprises a polarization-independent directional coupler.

5. An array according to claim 3, wherein said polarization-independent directional coupler comprises at least two buried waveguide cores disposed in lower index cladding.

6. An array according to claim 3, wherein the plural polarization-independent directional couplers comprise common horizontal and common vertical electrodes which contact the lower index cladding.

7. An array according to claim 6, wherein the common horizontal and common vertical electrodes are offset from the waveguide cores to reduce optical absorption by the electrodes.

8. An array according to claim 5, wherein the waveguide core comprises a polycrystalline material deposited on all amorphous substrate.

9. An array according to claim 8, wherein the amorphous substrate comprises silicon dioxide on silicon.

10. An array according to claim 8, wherein the polycrystalline material comprises Lead Lanthanum Titanate (PLT).

11. An array according to claim 5, wherein the waveguide cladding comprises an amorphous material deposited on an amorphous substrate.

12. An array according to claim 11, wherein the amorphous substrate comprises silicon dioxide on silicon.

13. An array according to claim 11, wherein the amorphous material comprises Lead Lanthanum Titanate.

14. An array according to claim 2, wherein the optically intersecting row and column waveguides each comprises polycrystalline Lead Lanthanum Titanate.

15. An array according to claim 3, wherein said CMOS controller comprises CMOS analog switches, and wherein said optical directional coupler comprises an electro-optical coupler controlled by said CMOS analog switches.

16. An array according to claim 15, further comprising an N×M switch memory array, and wherein said CMOS analog switches are controlled by said N×M switch memory array.

17. An array according to claim 16, further comprising N+M control lines, and wherein said N×M switch memory array is controlled by signals on said N+M control lines.

18. An array according to claim 17, wherein said CMOS analog switches, said N=33 M memory array, said addressing circuitry, and said N+M control lines comprise 5V/40V CMOS processed Silicon.

19. An array according to claim 1, wherein each optical crossbar switch comprises an optical coupler having a horizontal electrode and a vertical electrode, and further comprising a fixed, precision voltage source which controls horizontal and vertical electrode voltages.

20. An array according to claim 1, wherein each optical crossbar switch comprises an optical coupler having a horizontal electrode and a vertical electrode, and further comprising an adaptive precision voltage source which controls horizontal and vertical electrode voltages.

21. An array according to claim 20, further comprising an optimizer which controls the adaptive precision voltage source.

22. An array according to claim 21, wherein each optical crossbar switch comprises a row optical waveguide disposed to optically intersect a column optical waveguide, and further comprising a plurality Y couplers which combine outputs of the row waveguides to form an error output.

23. An array according to claim 22, wherein an optimizer input comprises the Y couplers error output.

24. An array according to claim 22, wherein the optimizer minimizes spurious crosstalk caused by incorrect bar and cross electrode voltages.

25. An array according to claim 1, wherein each optical switching element comprises an optical directional coupler and two semicircular waveguide segments, wherein each optical directional coupler comprises two waveguide cores, and wherein each core comprises Pb₍₁₋ₓ₎Laₓ(Zr_{y}Ti_{(1-y)})_{(1-x/4)}O₃,
where x is the fractional concentration of La in a range for PLT of 0<=x<=0.28 corresponding to 18% La, and
where y is the fractional concentration of Zr in a range for La content of range 0<=y<=1.0.

26. An array according to claim 1, wherein each optical switching element comprises an optical directional coupler, wherein each optical directional coupler comprises two waveguide cores and waveguide cladding, and wherein, in the presence of an electric field, the waveguide cores and the waveguide cladding exhibit both linear and quadratic electro-optical effects.

27. An array according to claim 1, wherein each optical switching element comprises a polarization-independent directional optical coupler, which transfers optical energy by coherent interference of the modes which propagate on adjacent waveguide segments.

28. An array according to claim 28, wherein each polarization-independent directional optical coupler comprises:
a first arc segment;
a first coupler segment coupled to the first arc segment;
a second coupler segment coupled to the first coupler segment;
a second arc segment coupled to the second coupler segment;
first and second electrodes disposed adjacent the first coupler segment; and
third and fourth electrodes disposed adjacent the second coupler segment.

29. An array according to claim 28, wherein a length of the first coupler segment is substantially equal to a length of the first coupler segment.

30. An array according to claim 1, wherein each optical switching element comprises two optical directional couplers at substantially right angles to each other, and a substantially 90 degree section of arc which directly connect the two couplers.

31. An array according to claim 1, wherein each optical switching element comprises two optical directional couplers at subsantially right angles to each other, a substantially 90 degree section of arc which directly connect the two couplers, and two appendage arcs of nominally 10 degrees each located at the extrema of the couplers.

32. Optical signal switching apparatus, comprising:
a substrate;
switching and addressing circuitry disposed on said substrate
an insulating layer disposed on said substrate and on said switching and addressing circuitry; and
a polycrystalline ferroelectric layer disposed on said insulating layer, said polycrystalline ferroelectric layer including:
a first plurality of optical signal carriers;
a second plurality of optical signal carriers, each disposed to receive an optical signal from at least one of said first plurality of optical signal carriers; and
a plurality of optical switching elements disposed to (i) receive control and addressing signals from said switching and addressing circuitry, and (ii) to switch an optical signal from one of said first plurality o f optical signal carriers to at least one of said second plurality of optical signal carriers.

33. Apparatus according to claim 32, wherein said polycrystalline ferroelectric layer comprises lanthanum doped lead zirconate titanate.

34. Apparatus according to claim 33, wherein each optical switching element comprises an optical directional coupler and two semicircular waveguide segments, wherein each optical directional coupler comprises two waveguide cores, and wherein each core comprises Pb₍₁₋ₓ₎Laₓ(Zr_{y}Ti_{(1-y)})_{(1-x/4)}O₃,
where x is the fractional concentration of La in a range for PLT of 0<=x<=0.28 corresponding to 18% La, and
where y is the fractional concentration of Zr in a range for La content of range 0<=y<=10.

35. Apparatus according to claim 34, wherein said optical directional coupler is substantially polarization-independent.

36. Apparatus according to claim 35, wherein said optical directional coupler comprises first and second coupler segments of substantially equal length, each coupler segment comprising a core disposed in cladding, a length of each core being substantially equal to a depth of the cladding.

37. Apparatus according to claim 36, further comprising first and second electrodes disposed on opposite sides of said first coupler segment, and third and fourth electrodes disposed on opposite sides of said second coupler segment, and wherein adjacent electrodes are of different polarity.

38. Apparatus according to claim 36, wherein said switching and addressing circuitry comprise CMOS structure.

39. A method of selectively switching optical signals between a first plurality of optical signal carriers and a second plurality of optical signal carriers, comprising the steps of;
disposing a plurality of optical switching elements so as to switch an optical signal from one of said first plurality of optical signal carriers to at least one of said second plurality of optical signal carriers;
disposing a plurality or electrodes adjacent said plurality of optical switching elements; and
controlling said plurality of electrodes to switch an optical signal from one of the first plurality of optical signal carriers to at least one of the second plurality of optical signal carriers such that the switched optical signal is polarization independent.

40. A method according to claim 39, further comprising the step of disposing addressing circuitry on a silicon substrate, and wherein the step of disposing the plurality of optical switching elements includes the step of disposing plurality of optical switching elements apart from the addressing circuitry.

41. A method according to claim 39, further comprising the step of disposing Y-couplers to couple noise incident on at least the first plurality of optical signal carriers, and further comprising the step of using the noise coupled in the Y-couplers to reduce noise in the switched optical signal.

42. A method of manufacturing an optical signal switching device, comprising the steps of:
forming electrode circuits on a substrate;
disposing a PLZT cladding layer on the electrode circuits;
disposing a PLZT core layer on the PLZT cladding layer;
forming at least two optical waveguides and at least one optical switching element in the PLZT core layer;
disposing another PLZT cladding layer on the at least two optical waveguides; and
disposing another electrode circuit on the another PLZT cladding layer.

43. A method according to claim 42, wherein the step of disposing a PLZT core layer includes the step of forming the cores by a spin-on Sol Gel process, and wherein the step of forming the at least two optical waveguides includes the step of forming the waveguides by reactive ion etching.

44. A method according to claim 43, further comprising the step of annealing the waveguides at a temperature sufficient to crystallize core material.

45. A method according to claim 44, wherein the step of disposing a PLZT cladding layer includes the steps of forming a low index cladding by spin-on Sol Gel, annealing the cladding at low temperature, and then planarizing the cladding by reactive ion etching.

46. A method according to claim 45, wherein the step of disposing another electrode circuit includes the step of fabricating the another electrode on the planarized cladding by photolithography.

47. A method according to claim 42, wherein the cladding material remains in the amorphous state.

48. A method according to claim 42, further comprising the step of forming a CMOS silicon controller beneath the PLZT cladding layer.

49. A method according to claim 48, further comprising the steps of annealing the PLZT cladding layer and the PLZT core layer at temperatures which are sufficiently low so as to not damage the CMOS silicon controller.

50. A method according to claim 48, further comprising the step of disposing a silicon dioxide layer over the CMOS silicon controller before the step of disposing the PLZT core layer.

51. A method of forming an integrated optical crossbar switch on a single substrate, comprising the steps of:
forming control and addressing circuitry on the single substrate;
forming an insulating layer over the control and addressing circuitry;
forming a first plurality of optical signal carriers on the insulating layer;
forming a second plurality of optical signal carriers on the insulating layer, each disposed to receive an optical signal loom at least one of said first plurality of optical signal carriers; and
forming a plurality of optical switching elements so as (i) to receive control and addressing signals from said control and addressing circuitry, and (ii) to switch an optical signal from one of said first plurality of optical signal carriers to at least one of said second plurality of optical signal carriers.

52. A method according to claim 51, wherein the step of forming the plurality of optical switching elements includes the steps of forming core and cladding layers comprising lanthanum doped lead zirconate titanate.

53. A method according to claim 51, wherein the step of forming the plurality of optical switching elements includes the steps of forming each optical switching element to include an optical directional coupler and two semicircular waveguide segments, wherein each optical directional coupler comprises two waveguide cores, and wherein each core comprises Pb₍₁₋ₓ₎Laₓ(Zr_{y}Ti_{(1-y)})_{(1-x/4)}O₃,
where x is the fractional concentration of La in a range for PLT of 0<=x<=0.28 corresponding to 18% La, and
where y is the fractional concentration of Zr in a range for La content of range 0<=y<=1.0.

54. A method according to claim 52, wherein said optical directional coupler is formed so as to be substantially polarization-independent.

55. A method according to claim 52, wherein said optical directional coupler comprises first and second coupler segments of substantially equal length, each coupler segment comprising a core disposed in cladding, a length of each core is formed to be substantially equal to a depth of the cladding.

56. A method according to claim 55, wherein the step of forming control and addressing circuitry includes the step of forming first and second electrodes disposed on opposite sides of a first coupler segment, and third and fourth electrodes disposed on opposite sides of a second coupler segment, wherein adjacent electrodes are of different polarity.
